(19) United States
(12) Patent Application Publication
(10) Pub. No.: US 2007/0181563 A1
(43) Pub. Date: Aug. 9, 2007

(54) PLASTIC FOOD PROCESSING UTENSILS COMPRISING A MAGNETICALLY SUSCEPTIBLE COMPONENT, METHODS OF USING, METHODS OF MAKING, AND PRODUCTS AND APPARATUS COMPRISING SAME

(75) Inventors: Marc Hiel, Zwijndrecht (BE); Clement Hiel, Rancho Verdes, CA (US); Paul Malcolm Puckett, Lake Jackson, TX (US)

Correspondence Address: GILBRETH & ASSOCIATES, P.C., PO BOX 2428, BELLAIRE, TX, 77402-2428, US

(73) Assignee: CLEAN BAKING PRODUCTS, BVBA, Zwijndrecht (BZ)

(21) Appl. No.: 11/307,391

(22) Filed: Feb. 5, 2006

(51) Int. Cl. H05B 6/12; A21D 8/02

(52) U.S. Cl. 219/621; 426/19

(57) ABSTRACT

A baking utensil comprising a main body consisting essentially of magnetically insusceptible material selected from the group consisting of polymeric material, ceramic, glass, tile, stone, and any combinations thereof, and comprising a magnetically susceptible component supported by the main body.

### BACKGROUND OF THE INVENTION

1. Field of the Invention

The present invention relates to products and apparatus for processing food products, and to methods of making and using such products and apparatus. In another aspect, the present invention relates to products and apparatus comprising polymeric utensils for processing food products, and to methods of their making and using. In even another aspect, the present invention relates to products and apparatus comprising plastic utensils for processing food products wherein said utensils comprise a magnetically susceptible component, and to methods of their making and using. In still another aspect, the present invention relates to products and apparatus comprising plastic utensils for heating, baking, cooling, and/or freezing food products wherein the utensil comprises a magnetically susceptible component.

2. Description of the Related Art

Many materials have been used to make the sheets, pots, pans, tins, and other utensils used in baking food products such as, for example, meats, dairy products, vegetables, combinations of meat, vegetables, dairy products, and bakery goods including flour-based products such as, but not limited to, cakes, cookies, pies, pastries, and breads.

Traditionally, cookware utensils such as baking sheets, pots, tins, and pans are made of metal, most commonly steel or aluminum, but a variety of other materials including ceramic, glass, tile, and stone materials are also used. Often in order to allow for easy removal of a food product from the utensil, a coating is applied to the surface portion of the utensil which contacts the food (herein referred to as a food contact surface). The coating materials most often used are TEFLON (a perfluorinated hydrocarbon) and silicone based resins. Another method used to enhance the release of baked goods from cookware is the application of fats and/or oils on the food contact surface.

Breads and pastries are some of the most demanding foods that are baked. Not only must breads and pastries be thoroughly cooked, but generally it is desired for the portion of the bread or pastry product consisting of glutenized flour to brown and form a crust or skin of acceptable thickness as a result of the baking process. It is commonly accepted in the industry that an intrinsic value of using metal pans to cook bread and pastries is that metals are good heat conductors, and conducting heat to the surface of the bread allows it to brown properly. Consequently, most large commercial bakeries have used metal pans (sometimes more commonly referred to as tins in English speaking countries outside of the US) to bake their bread and pastries, because of its low cost and intrinsically good baking properties.

A more recent development is the use of plastic bakeware which has numerous advantageous properties over metal including ease of cleaning, non-corroding, light weight, high durability and easy release of baked products without the need of applying additional coatings or oils (i.e., inherent non-stick food contact surfaces). It has been discovered that despite the inherent insulating properties of plastic, the use of plastic bakeware for baking bread and pastry products yields browning and crusting equal to or superior to that obtained with use of metal pans. Thus, many bakeries have begun using plastic bakeware to take advantage of their easy cleaning, non-corroding, light weight, and durability, plus the non-stick properties allowing for easy release of baked products without the need for additional coatings or oils.

In large commercial bakeries which make thousands of loaves of bread each day there is a need to maintain very tight control of automated processes. Control of parameters such as temperature, portion size and baking time is necessary in reproducibly making breads, pastries, pies, or cakes, every day with exactly the same quality. As processes in large commercial bakeries became increasingly automated, many bakeries took advantage of the magnetic susceptibility of steel bakeware and developed processes in which magnets are used to aid in the handling of this magnetically susceptible bakeware. In these automated processes, the movement of bakeware is often manipulated and controlled by magnetic attraction. The bakeware can be moved from one belt to another belt magnetically, or magnetically attached to the top or bottom of a moving belt. Magnetically susceptible bakeware can also be held in a fixed position using magnets while ingredients are metered into the bakeware or removed from the bakeware following the baking process.

The following are just a few of the patents in the bakeware art.

U.S. Pat. No. 4,069,962, issued Jan. 24, 1978 to Holmqvist, discloses a composite baking mold comprising a plurality of individual mold spaces made by extruding elongated portions of aluminum or other light metal and cutting off the portions at an angle to their longitudinal axes and assembling the cut components by welding or riveting to form lengthwise and cross-width components defining the partial molds of the composite mold.

U.S. Pat. No. 4,895,766, issued Jan. 23, 1990, to Saad, discloses coating compositions for bakeware release which contain (a) base silicone resin having alkoxy or acyloxy functional groups and a viscosity between 10 to 200,000 centipoise; (b) base polydiorganosiloxane fluid having functional groups to react with the base resin; (c) a hydroxy functional polyphenylsiloxane resin; (d) a nonthermosettable polydiorganosiloxane fluid; and (e) an effective amount of condensation catalyst.

U.S. Pat. No. 5,004,121, issued Apr. 2, 1991, to Howe, discloses a non-metallic unitary baking pan, and especially a baking pan made of plastic, including foam plastic, paper or plastic laminated paper in which a cake or cake-like product can be baked, which baking pan has portions thereof which are thicker and have greater insulating effect than other portions to more uniformly and evenly distribute the heat produced during the baking operation throughout the cake batter or dough being baked.

U.S. Pat. No. 5,146,840, issued Sep. 15, 1992, to Hedenberg, discloses an automatic baking apparatus for making food products in piece form from dough-like substances which apparatus has holding means adapted to be fixed to the top and bottom edges of a flexible sealable mixbag containing dry ingredients and water.

U.S. Pat. No. 5,465,654, issued Nov. 14, 1995, to Lampi et al., discloses a convenient serving-size pan with flange and flanged lid removably attached by a hinge, enabling a wide range of pourable, particulate, and solid foods to be cooked in quantity in forced-air convection ovens.

U.S. Pat. No. 6,230,360, issued May 15, 2001, to Singleton et al., discloses a baked good pan cleaner having a magnetic belt conveyer in which a magnet is located under the belt to hold the pan in position while in contact with brushes.

U.S. Pat. No. 6,250,871, issued Jun. 26, 2001, to Le Crone, discloses a conveyor for transporting and inverting strap pans or other pans used for baking. The conveyor includes a closed-loop drive chain to which a number of pan cars are pivotally attached. The pan cars are provided with magnetic bars that create attractive force to hold the strap pans to the pan cars. The conveyor also includes an incline guide. When the conveyor is actuated, the pan cars run against the incline guide so as to cause the initial inversion of the pan cars. As the pans cars are inverted they abut against a positioning rail located along side of the drive chain. The positioning rail is shaped to control both the rate at which the pan cars are inverted from their normal upright position and then it is further shaped to force the pan cars to then return to their initial upright position. The inversion of the pan cars causes a like inversion of the strap pans secured to the pan cars. Thus, this conveyor is used to invert pans so as to employ gravity in order to foster the removal of debris from the pans.

U.S. Pat. No. 6,463,844, issued Oct. 15, 2002, Wang et al., discloses a baking pan which includes a lower pan part having a respective periphery and at least one raised area spaced from that periphery.

U.S. Pat. No. 6,698,336, issued Mar. 2, 2004, Siegel et al., discloses a baking dish which includes a generally shallow platter made of ceramic material suitable to withstand a baking environment and having a baking surface defining a supporting plane on which a baked product can be made.

U.S. Pat. No. 6,737,164, issued Mar. 18, 2004, to Araki et al., discloses composite materials for cooking apparatuses which are produced by applying, to a substrate, a material comprising a fluorine-containing polymer having an excellent adhesive property to the substrate without necessitating complicated steps and are excellent in heat resistance, non-sticking property, stain-proofing property, water- and oil-repelling property, stain-removing property, chemical resistance, rust-preventing property, antibacterial property, resistance to energy ray and abrasion resistance.

U.S. Pat. No. 6,869,059, issued Mar. 22, 2005, to Sloan et al., discloses a pan for baking a batter or dough to provide a baked good, such as muffins or cupcakes. The pan may be made out of metal foil, such as aluminum, or a non-metallic, non-conductive material.

Despite advances in the art, traditional cookware items suffer from a number of disadvantages. For example, the disadvantages of metal pans include their heavy weight, their susceptibility to corrosion, and the requirement of treating their food contact surface with a coating and/or oil in order to enable easy removal of the cooked food. Disadvantages of ceramic, glass, tile, and stone pans include their heavy weight and their fragile nature. In addition, cookware products made from materials such as plastics, ceramic, glass, tile, stone, and aluminum are non-magnetic and thus incompatible with the food industry's automated food preparation processes and systems which rely on magnetic attraction as a key integral part of their operation.

Thus, there is a need in the art for cookware that is easy to clean, non-corroding, light weight, durable and provides easy release of baked products without the need for additional coatings or oils. There is also a need in the art for cookware made from non-magnetic material wherein the cookware is compatible for use in the food industry's automated food processing systems comprising magnet-dependent processes.

There is a need in the art for improved baking processes utilizing such cookware.

These and other needs in the art will become apparent to one of skill in the art upon review of this specification, claims and drawings.

### SUMMARY OF THE INVENTION

One embodiment of the present invention provides a temperature resistant surface comprising a magnetically insusceptible cooking surface, a magnetically insusceptible support member supporting the cooking surface, and a magnetically susceptible component supported by the support member.

Another embodiment of the present invention provides a utensil formed from magnetically insusceptible polymeric material wherein said utensil comprises a magnetically susceptible component at least partially embedded therein.

Even another embodiment of the present invention provides a baking utensil comprising a main body consisting essentially of magnetically insusceptible material selected from the group consisting of polymeric material, ceramic, glass, tile, stone, and any combinations thereof, and comprising a magnetically susceptible component supported by the main body.

Still another embodiment of the present invention provides a method of processing a food product comprising the steps of: a) positioning a utensil at a foodstuff depositing station, b) depositing foodstuff onto said utensil, and c) moving said utensil supporting said foodstuff to one or more processing stations, wherein the utensil comprises a main body consisting essentially of magnetically insusceptible material selected from the group consisting of polymeric material, ceramic, glass, tile, stone, and any combinations thereof, and comprises a magnetically susceptible component supported by the main body, and wherein the moving of step c) is accomplished by magnetically engaging the magnetically susceptible component to facilitate the moving.

Yet another embodiment of the present invention provides an apparatus for processing food comprising: a) a utensil b) a transportation device for moving food processing utensils, c) a depositing station for depositing foodstuff onto food processing utensils, d) at least one oven for cooking or baking said deposited foodstuff, wherein the utensil comprises a main body consisting essentially of magnetically insusceptible material selected from the group consisting of polymeric material, ceramic, glass, tile, stone, and any combinations thereof, and comprises a magnetically susceptible component supported by the main body, and wherein the transportation device comprises a magnetic for magnetically engaging the magnetically susceptible component.

Even still another embodiment of the present invention provides a method of moving a utensil from a first place to a second place, wherein the utensil comprises a main body consisting essentially of magnetically insusceptible material selected from the group consisting of polymeric material, ceramic, glass, tile, stone, and any combinations thereof, and comprises a magnetically susceptible component supported by the main body, said method comprising the steps of: a) magnetically engaging said magnetically susceptible material with a transportation device, and b) moving said utensil from a first place to a second place.

Still yet another embodiment of the present invention provides a food product comprising a utensil supporting a foodstuff wherein the utensil comprises a main body consisting essentially of magnetically insusceptible material selected from the group consisting of polymeric material, ceramic, glass, tile, stone, and any combinations thereof, and comprises a magnetically susceptible component supported by the main body

Yet even another embodiment of the present invention provides a method of making a utensil comprising a main body consisting essentially of magnetically insusceptible material, and comprising a magnetically susceptible component supported by the main body, the method comprising the steps of: a) placing magnetically susceptible material in a predetermined position in an injection die, b) injecting polymeric resin into said die, and c) forming a utensil in a predetermined form.

These and other embodiments of the present invention will become apparent to those of skill in the art upon review of this application, including its drawings and claims.

### BRIEF DESCRIPTION OF THE DRAWINGS

FIG. 1 is a drawing showing MSM component 10 of the present invention. MSM 10 is a single piece and is in the shape of a circular disc having hole 20 through its center.

FIG. 2 is a drawing showing a cross-sectional view of utensil 50 having bottom 60, sides 70 and edge 80. Embedded in bottom 60 is MSM component 10 of FIG. 1.

FIG. 3 is a schematic representation of processing/transporting apparatus/process 200 of the present invention, showing utensil 240 of the present invention, having MSM component 241, positioning apparatus 201 having articulating arm 236 with magnet 235 for engaging MSM component 241, and a plurality of processing stations 201, 203, 204, 208, 211 and 215, with conveyor belt 218 between one or more stations, with positioning apparatus 201 suitable for positioning utensil 240 at any station or conveyor belt, or otherwise moving utensil 240 from a point A to a point B.

### DETAILED DESCRIPTION OF THE INVENTION

The present invention provides utensils having main body consisting essentially of inherently magnetically insusceptible with a magnetically susceptible component in contact with the main body. The invention also provides methods of using and methods of making said utensils, and products and apparatus comprising said utensils. This main body will be the portion of the utensil in contact with the foodstuff.

For the known polymeric bakeware consisting essentially of inherently magnetically insusceptible materials (i.e., essentially no magnetically susceptible materials) and methods of using them, the improvement of the present invention, is the incorporation of a magnetically susceptible material so that the bakeware can engage a magnetic device.

The utensils of the invention may be used to mix, contain, store, transport, cool, freeze, heat, bake, cook, steam, broil, fry, or any combinations thereof, a food product or any other product or material. Generally the utensils of the invention comprise at least one food contact surface. Preferably, the utensil is suitable as a baking tin (also referred to as a pan or dish).

The product or material may be of a dry or liquid form, or any mixture thereof. Generally the utensils are used for processing a food product, preferably for heating a food product, more preferably for cooking a food product, and even more preferably for baking a food product.

As described herein, the term “processing” as it relates to food may refer to any process carried out on a food item or food product and includes, but is not limited to, assembling, mixing, layering, preparing, heating, cooking, baking, steaming, broiling, frying, poaching, cooling, and/or freezing a food item or product. It should be understood that if a utensil of the invention is utilized in a frying process, generally the process comprises at least partially submerging a utensil of the invention containing foodstuff into oil rather than exposing the utensil to an open flame. In the practice of the present invention, the preferred food processing is baking.

The food item may be any food including meats, fruits, vegetables, dairy products, any and all combinations of meats, fruits, and vegetables, dairy products, baked goods including but not limited to breads, pasteries, cakes, pies, and cookies, and baked goods comprising meats, and/or fruits, and/or vegetables, and/or dairy products. While the utensils of the present invention are generally used for food products, it is entirely within the scope of the invention to use the utensils to hold, contain, transport, or process any non-food item or product. In the practice of the present invention, the preferred food item is baked goods.

The utensils of the invention may be made from any magnetically insusceptible material such as polymeric material, ceramic, glass, tile, stone, and any combination thereof. A preferred material is any polymeric material. One advantage in using polymeric materials for the utensils of the present invention is the ability to rapidly form polymeric material into articles having any of a large variety of shapes and forms by processes such as injection (blow) molding, extrusion, vacuum forming, sheet molding, and all other processes known in the art useful for polymeric material. Generally, polymeric materials have long entangled chains and these materials can be softened and manipulated into a variety of shapes when heated. With some polymeric material formulations, light to very heavy cross-linking of the polymeric chains can occur while heating and forming the finished article. This cross-linking can be useful such as, for example, in the case of thermoplastics, as it can result in additional stiffness properties which are maintained at elevated temperatures, thus providing heat resistant properties. With both organic and inorganic thermosetting materials, this cross-linking process thermally sets the polymer and defines the final shape of the cured product. In addition, use of polymeric material results in food utensils having numerous advantageous properties such as ease of cleaning, non-corroding, light weight, high durability, and easy release of food products without the need to apply special non-stick coatings.

The polymeric materials useful in the present invention may be any material suitable for use with food items and for food processing applications. The polymeric materials used in the present invention are thus suitable for use in the high temperature ranges required for heating, cooking or baking food products such as high temperatures generally in the range of 100 to 400° C., preferably in the range of 125 to 300° C., more preferably in the range of 150 to 250° C., and/or low temperature ranges used for cooling and freezing food products such as low temperatures generally in the range of −80 to 10° C., preferably in the range of −65 to 5° C., more preferably in the range of −40 to 0° C. The polymeric material by itself is inherently insusceptible to magnetic fields and is thus non-magnetic. Polymeric materials suitable for use herein include organic polymeric resins and inorganic materials as well as blends. Organic polymeric resins include both thermoplastic and thermosetting materials, as well as thermoplastic polymers which are cross-linked. Thermoplastic materials suitable for use in the present invention include but are not limited to syndiotactic polystyrenes, nylons (polyamides), modified nylons, high temperature nylons, polyesters, modified polyesters, high temperature polyesters, liquid crystal polymers, polypropylenes, acid, acid-derivative and anhydride modified polyolefins, ionomers, polymethylpentene, polyetherimides, polysulfones, polyphenylsulfones, polyethersulfone, polyphenylene sulfide (including PPS, PPSK (“ketone”), and PPSS (“sulfone”)), polyimides, polyamideimides, polyesteramides, and similar such materials or blends of any two or more of these materials. Inorganic materials include but are not limited to glasses, tile, stone, ceramics and cements. Non-limiting examples of suitable polyolefins include those formed by polymerizing one or more C1 to C12 olefins, preferably one or more C1 or C2 olefins, non-limiting examples of which include polyethylene and polypropylene homopolymers and copolymers. Thermosetting polymeric resins include but are not limited to epoxies, phenolics, melamines, polyamines, polyureas, bis-maleimides, polycyanates, similar such materials or blends of these materials.

The polymers useful herein may be used with or without additional fillers and reinforcements. In a preferred embodiment of the invention, the polymers utilized comprise fibrous reinforcement to provide plastic composite materials having increased strength and durability. Typical reinforcements include, for example, fibers of glass, carbon, and Aramid, but also include naturally occurring organic fibers such as fibers of cotton, wool, or silk, or the inorganic fibers of silicates or basaltic origin. In addition to having a relatively low cost, glass fibers have very good compatibility and processability with polymeric materials. Glass fibers are particularly useful with polymeric materials and result in a material having excellent strength, excellent toughness, and a high heat distortion temperature. Utensils of the invention that are glass loaded generally comprise about 5% to about 60% glass based on the weight of the utensil, preferably about 20% to about 40% glass based on the weight of the utensil.

The shape and form of the utensils of the present invention may be any of the shapes and forms known in the art, or any other as desired for a particular application. For example, the utensil may be in the form of a flat sheet like a cookie sheet and/or a pizza pan, a sheet having indented sections like a muffin pan, an annular pan like a bundt pan, a shallow pan like a pie pan, a deep pan like a cake pan or those pans used to bake breads, a deep dish like those for deep dish pizzas, or a tubular horn form like a creamhorn form. The utensil may also be in the form of a rack or strap designed to accommodate one or more food utensils thereby allowing efficient movement and handling of multiple food utensils by moving and handling them as a single unit. The utensils of the invention may be any regular or irregular polygonal or curvilinear shape including but not limited to circular, square, rectangular, triangular, tubular, and any other shape useful for a food processing utensil. As known in the art, the edge of the utensil may be smooth, serrated, or undulated, the edge may be flat or raised to form a lip. The surfaces of the utensil may be smooth, serrated, slit, undulated, perforated, comprise indentations or protrusions. The top, bottom and side surfaces of the utensil may be of the same or different topography. In addition, the inventive utensils may be one piece, or they may comprise two or multiple pieces. If the utensil comprises two or more pieces, the two or more pieces may be separate from one another, or they may be connected to one another by any connecting means known in the art. Generally the utensil is a pan, tray, rack or sheet having a circular, square or rectangular shape, preferably the utensil is a pan, tray, rack or sheet and has a circular, square or rectangular shape, more preferably the utensil is a pan like a cake pan or bread baking pan, and has a circular, square or rectangular shape, and may be partially or fully filled with a flowable material, such as dough or batter.

While the utensils of the invention comprise material of a magnetically insusceptible nature, they are made to be magnetically susceptible by association with a magnetically susceptible material (MSM). The MSM may be associated with the utensil in any number of ways such as, for example, affixed to any portion of a side, bottom or top surface of the utensil, partially or entirely embedded in any region of a side, bottom or top surface of the utensil, or encapsulated throughout any portion or region of any one or more surfaces of the utensil, or through out the majority of any one or more surfaces of the utensil. In one embodiment of the invention, the MSM is added as a powder, pellets, granules, or solution to the polymeric resin prior to or during the process of fabricating the resin into a utensil.

A piece of magnetically susceptible material may be associated with the utensil by attaching said MSM to the utensil by any one or more single or combination of attachment, connection, or coupling means such as, for example, by use of clips, pins, nails, screws, bolts, seams, clamps, adhesives, frictionally engageable connecting means, or interlocking connecting means. Because the utensils of the invention are useful in processes involving one or more temperature changes, and exposure to high and/or low temperatures, it is necessary for the attachment means to be able to withstand exposure to such temperatures and temperature changes without loss of integrity. Similarly, the utensils of the invention may be used in processes involving use of water, steam, liquids and/or food items, thus the attachment means must be able to withstand exposure to moisture and/or food products without loss of integrity, and without corrosion, degradation, or oxidation.

The MSM may be embedded in the polymeric resin. This can be accomplished in a number of ways, one of which is placing the MSM inside an injection molding die and injecting a polymeric material into the die in such a way that it encapsulates at least a portion of the MSM while forming the utensil. It may be necessary to hold the MSM in a fixed position inside the injection molding die. Any holding means such as, for example, pins, a magnet, or any combination of holding means may be used for the purpose of holding the MSM in place while the utensil is formed. The MSM may be partially or fully embedded in the polymeric resin. Generally at least 25% of the MSM is embedded in the polymeric resin, preferably at least 50%, more preferably at least 75%, even more preferably at least 90%, still more preferably at least 95%. In a particularly preferred embodiment, at least 99% of the MSM is embedded in the polymeric resin. By embedding the MSM in the utensil, corrosion, degradation and oxidation of the MSM is kept at a minimum and are thus generally negligible.

While generally only one piece of MSM is attached, connected coupled, or embedded to one utensil of the invention, it is within the scope of the invention to attach, connect, couple or embed more than one piece of MSM to one utensil. The more than one MSM pieces may be the same or different shape, they may be the same or different size, they may comprise the same or different material, and they may be associated with the same or different surface of the utensil. The MSM may be localized to any one region of at least one surface or spread throughout any at least one surface, or any combinations thereof.

The magnetically susceptible materials suitable for use in the present invention may be any single material or mixture of material capable of imparting magnetic susceptibility to the utensil and may comprise, for example, iron, steel, nickel, cobalt, alloys of these materials, or any combination thereof. Additional materials of interest are magnetic materials of samarium cobalt, neodymium iron boron, aluminum nickel cobalt, and alloys of gandolinium, dysprosium, and neodymium. Other materials of interest are those that are readily available as powders of liquids that can be added to the polymeric material during the moulding process to distribute the MSM through the part, including but not limited to Ferrite, Magnetite, and Ferrofluid. The MSM may be associated with any one or more polymeric material, such as those listed previously in the application, prior to association with the utensil of the invention. For example, the MSM may be connected, coupled, attached or embedded to a piece of polymeric material which is then connected, coupled, attached or embedded to a utensil of the invention.

If the utensil is to be used for food products, the MSM is also suitable for use with a food product. The MSM component of the utensil of the present invention may have any form such as, but not limited to, the shape of a plate, a ring, a disc, a rod, a bar, a strip, a sphere, and may be any curvilinear or polygonal shape such as, for example, square, rectangular, circular, oval, triangular, the shape may be regular or irregular. The surfaces of the MSM component may be continuous, perforated, grooved, indented, slit, or any possible topography.

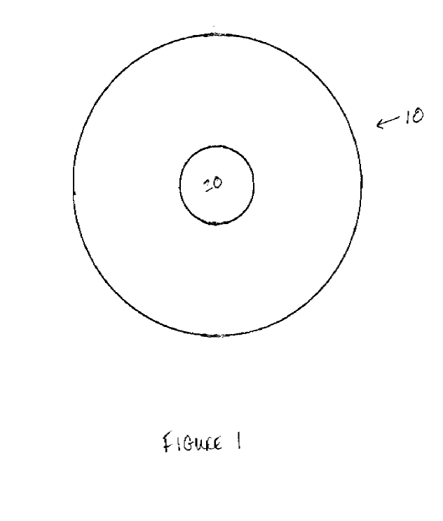

Referring now to FIG. 1 there is shown an example of a MSM component useful in the present invention. As shown, FIG. 1 is a drawing showing MSM component 10 of the present invention. MSM 10 is a single piece and is in the shape of a circular disc having hole 20 through its center. The MSM component depicted in FIG. 1 is a single piece and is in the shape of a flat annular disc. The surface of the MSM component is continuous.

With respect to the size of the MSM component, it may be any size so long as it confers sufficient magnetic susceptibility to the target utensil to render the utensil compatible for use in magnet-dependent and magnet driven processes and processing systems. Preferably, the size of the MSM component will not impede the processing of the utensil in any subsequent processes involving the utensil. Regardless of the shape, size, composition, placement, and number of MSM pieces or components, a critical requirement for the MSM component used in the present invention is that it imparts magnetic susceptibility to the target utensil of sufficient strength to render said utensil compatible for use in magnet-dependent and magnet driven processes and processing systems comprising such processes.

The temperature resistant surface of the present invention comprises a magnetically susceptible component. The magnetically susceptible component may be located at any region of the surface or spread throughout any portion or all of the surface. The surface may comprise more than one magnetically susceptible component. Generally, the surface comprises one magnetically susceptible component of the invention and it is localized at one region of the surface. The surface is generally made of polymeric material, ceramic, glass, tile, stone, or any combination thereof, and is preferably polymeric material. The magnetically susceptible component is generally made of a metal, preferably a steel, more preferably a stainless steel. Generally the surface of the invention is resistant to and can withstand exposure to high temperatures such as those used to heat, bake, or cook food products, or low temperatures such as those used to cool and freeze food products, or both high and low temperatures. Generally the high temperatures are in the range of 100 to 400° C., preferably in the range of 125 to 300° C., more preferably in the range of 150 to 250° C., and the low temperatures are generally in the range of −80 to 10° C., preferably in the range of −65 to 5° C., more preferably in the range of −40 to 0° C. In addition, the surface is easy to clean, resists corrosion and degradation, has non-stick properties, and is reusable. In a preferred embodiment, the surface of the invention is a baking surface.

The utensils of the present invention generally comprise a magnetically susceptible component. As discussed previously in the present application, the utensils of the invention may be any shape and form as necessary for the intended purpose of said utensil, and they may be made from any magnetically insusceptible material such as polymeric material, ceramic, glass, tile, stone, or any combination thereof. Generally the material is any polymeric material, preferably any material selected from the group consisting of thermoplastic material, cross-linked thermoplastic resin, thermosetting plastic resin, inorganic thermoset material such as, for example, a ceramic or cement, or any combination thereof. Preferred thermoplastic materials of the invention include but are not limited to syndiotactic polystyrenes, nylons (polyamides), modified nylons, high temperature nylons, polyesters, modified polyesters, high temperature polyesters, liquid crystal polymers, polypropylenes, acid, acid-derivative and anhydride modified polyolefins, such as polyethylenes, polypropylenes and any copolymers thereof, ionomers, polymethylpentene, polyetherimides, polysulfones, polyphenylsulfones, polyethersulfone, polyphenylene sulfide, polyimides, polyamideimides, polyesteramides, and similar such materials or blends of any two or more of these materials. Preferred thermosetting plastics include but are not limited to epoxies, phenolics, melamines, polyamines, polyureas, bis-maleimides, polycyanates, similar such materials and blends of any two or more of these materials. The polymeric material may be used with or without additional fillers and reinforcements. As described previously in the application, glass fibers are particularly useful with polymeric materials and result in a material having excellent strength, excellent toughness, and a high heat distortion temperature. Preferred utensils of the invention are glass loaded and generally comprise about 5% to about 60% glass based on the weight of the utensil, preferably about 20% to about 40% glass based on the weight of the utensil. Generally the utensil is a pan, tray, rack or sheet having any regular or irregular polygonal shape such as but not limited to circular, square or rectangular shape, preferably the utensil is a pan, tray, rack or sheet and has a circular, square or rectangular shape, more preferably the utensil is a pan like a cake pan, pie pan, or bread baking pan, and has a circular, square or rectangular shape. The utensil preferably has sides enabling it to be at least partially filled with a flowable material, such as dough or batter. The preferred location of the magnetically susceptible material on or within the utensil of the invention will depend on the processing equipment with which the utensil is to be used. Generally, the magnetically susceptible material will be positioned on or within the utensil of the invention in order to best suit the processing apparatus.

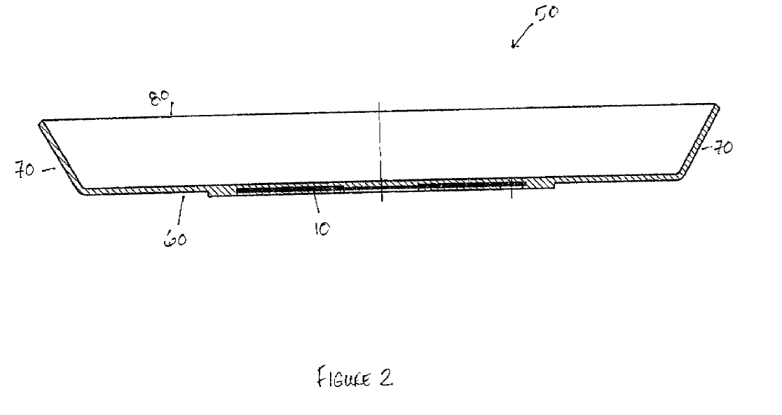

Referring now to FIG. 2, there is shown one embodiment of a utensil of the invention wherein said utensil comprises magnetically susceptible material embedded in its bottom surface. FIG. 2 is a drawing showing a cross-sectional view of utensil 50 having bottom 60, sides 70 and edge 80. Embedded in bottom 60 is MSM component 10 of FIG. 1. The utensil depicted in FIG. 2 is rectangular in shape and the magnetically susceptible material embedded therein is also rectangular in shape. The utensil shown has sides enabling it to be at least partially filled with a flowable material, such as dough or batter.

The method of the present invention of processing a food product, generally comprises the steps of positioning a utensil of the invention at a foodstuff depositing station, depositing foodstuff onto the utensil, and moving the utensil loaded with foodstuff to one or more processing stations. The processing stations may be any one or more of the following, a heating station, a cooking station, a baking station, a cooling station, and a freezing station. The depositing station may involve more than one deposit of foodstuff into the utensil, and each deposit may comprise the same or different ingredients. The depositing of foodstuff into the utensil may comprise any one or more of mixing, stirring, or shaking the foodstuff. Generally at least some of the positioning and moving of the utensil involves magnetically engaging a magnet of a transportation device with the magnetically susceptible component of the utensil.

FIG. 3 is a schematic representation of processing/transporting apparatus/process 200 of the present invention, showing utensil 240 of the present invention, having MSM component 241, positioning apparatus 201 having articulating arm 236 with magnet 235 for engaging MSM component 241, and a plurality of processing stations 201, 203, 204, 208, 211 and 215, with conveyor belt 218 between one or more stations, with positioning apparatus 201 suitable for positioning utensil 240 at any station or conveyor belt, or otherwise moving utensil 240 from a point A to a point B. Processing stations may be any type of processing station as described herein, non-limiting examples of which include cutting, slicing, partitioning, assembling, mixing, layering, preparing, heating, cooking, baking, steaming, broiling, frying, poaching, cooling, and/or freezing.

In a preferred method of the present invention, preferably, the foodstuff is a dough, the utensil is a pan, and the utensil having dough deposited thereon is processed at a baking station where the dough is baked into a baked product such as, for example, bread. In another preferred embodiment, the utensil is a pie tin onto which a pie crust is deposited, followed by a step of depositing pie filling contents onto some portion of the pie crust. The pie tin containing crust and filling is processed at a baking station where the pie crust and pie filling are baked into a baked product such as, for example, a pie. In this preferred embodiment, there may be an additional step of depositing a top crust over the pie filling contents prior to the baking process.

Generally, the baking process of the invention comprises exposing a utensil containing foodstuff to any one of the following three temperature ranges: 1) a freezing process between −40° C. and 0° C. which slows or stops chemical and biological processes such as, for example, fermentation which causes bread to rise; 2) the use of temperatures between about 150° C. to 200° C. in order to bake many cakes, muffins, cookies, and pies; and 3) about 200° C. to 250° C. which is used to bake breads and many pastries. Generally, if the foodstuff is exposed to a freezing temperature the duration of said exposure is at least 5 seconds, preferably at least 2 minutes, more preferably at least 5 minutes, even more preferably at least 15 minutes, and still more preferably at least 30 minutes. Generally, if the foodstuff is exposed to a baking temperature the duration of said exposure is at least 10 minutes, preferably at least 20 minutes, even more preferably at least 30, and still more preferably at least 40 minutes.

The process may further comprise the step of moving the processed utensil to a finishing station for finishing. Finishing the food product includes applying thereto any additional ingredient, topping, coating, or combinations thereof, after the processing of the food product, for example dusting or sprinkling sugar, flour, or any other ingredient or combinations there of, atop a baked food product. In this embodiment finishing may comprise applying a protective packaging to preserve the quality and integrity of the foodstuff. The packaging may be any known in the art and includes, for example, bags, boxes, covers, sleeves, casings, and combinations thereof, and may be made of any material useful for such including but not limited to plastics, papers, cardboards, and foils.

The food processing apparatus of the present invention, comprises a transportation device for moving utensils of the invention, to at least one processing station, for example, a depositing station for depositing foodstuff onto utensils of the invention, or a cooking or baking station. The apparatus may further comprise at least one cooling station for cooling said foodstuff. The apparatus may further comprise at least one a packaging station for packaging utensils of the invention supporting a processed foodstuff in a protective packaging to preserve the quality and integrity of the foodstuff. The packaging may be any known in the art and includes, for example, bags, boxes, covers, sleeves, casings, and combinations thereof, and may be made of any material useful for such including but not limited to plastics, papers, cardboards, and foils. Generally the transportation device comprises a magnet which is magnetically engageable with the magnetically susceptible component of the utensil of the invention. The transportation device may be any known in the art, such as, for example, any type of conveyer or mechanical arm.

The present invention also provides a method of moving items from one place to another place. The item may be any item having a magnetically susceptible component. Preferably the item is a utensil of the invention comprising a magnetically susceptible component. The method comprises the steps of engaging a magnet with the magnetically susceptible component of the utensil, and moving the utensil from a first place to a second place. Generally the utensil comprises a magnetically susceptible material at least partially embedded in a side, edge, top or bottom surface of said utensil wherein exposure of said side, edge, top or bottom surface of the utensil to the magnetic field of the magnet results in the utensil being magnetically engaged with the magnet. Preferably the magnetically susceptible material is at least partially embedded in a side, edge, or bottom surface of said utensil. The magnet may be part of a mechanical arm, part of a conveyer system, or on or part of any other apparatus known in the art to be of use for automated magnet-dependent movement of items.

The method may further comprise moving the item to a subsequent place or places, and these subsequent movements may involve use of the same arm, conveyor, or other movement means, or may involve a different arm, conveyor, or movement means. When the item has been moved from one place to another place, the magnet may be disengaged from the utensil, or the magnet may remain engaged with the utensil and be used for any subsequent movement of the item. While at least some of the moving of the item involves magnetically engageable transportation devices, it is also possible that some of movements of the item are carried out in a magnet independent manner. Although this particular embodiment describes a method wherein the first step of moving the item is magnet-dependent, it is entirely within the scope of the invention that the first step of moving the item is independent of any use of a magnet or magnetic field.

Products of the present invention generally comprise a utensil of the invention supporting foodstuff. The product may comprise a protective packaging to preserve the quality and integrity of the foodstuff. The packaging may be any known in the art such as, for example, bags, boxes, covers, sleeves, casings, and combinations thereof, and may be made of any material useful for such including but not limited to plastics, papers, cardboards, and foils. The foodstuff may be raw, partially cooked, fully cooked, baked, and any combination thereof, and be at any temperature and thus be frozen, chilled, at room temperature, warm, or hot. The foodstuff may contain ingredients that are raw, partially cooked, fully cooked, baked, and any combination thereof. Generally the foodstuff is baked, preferably baked bread, baked pie, or baked cake. The cake or pie may be any type of cake or pie known in the art and may be in any form, shape, and size. The bread may be any bread known in the art including but not limited to white breads, wheat breads, grain breads, potato breads, and may be in any form such as for example loaves, rolls, knots, baguettes, buns.

According to yet even another embodiment of the present invention, there is provided a method of making a utensil wherein the utensil comprises polymeric material and a magnetically susceptible component. Generally the method comprises the steps of placing magnetically susceptible material of the invention in a predetermined position within an injection die used to form a polymeric utensil of the invention as a predetermined form. As described in detail previously in the present application, generally, the magnetically susceptible material useful herein may comprise any one or more of iron, steel, nickel, cobalt, alloys of these materials, or any combination thereof. In a preferred embodiment, the magnetically susceptible material comprises metal, preferably steel, more preferably stainless steel. The male and female sections of the die are closed together and heated to the appropriate moulding temperature such as, for example, by means of a hot fluid flowing through the die. An extruder then injects heated polymeric material into the mould and the magnetically susceptible material is at least partially embedded in the polymeric resin. Once the resin has cooled sufficiently and can hold its shape, the mould is opened the final product is ejected. If necessary, the magnetically susceptible material may be held in place on the die so its position is not altered during the moulding process. This may be achieved by using any one or combination of holding means, such as for example, small pins, and/or a magnet. Any and all methods and apparatus known in the art for extruding and moulding polymeric material are useful for making the inventive utensils. The final product is a food processing utensil comprising a magnetically susceptible material embedded therein. In a particularly preferred embodiment, the utensil is a baking utensil. Generally the resulting utensil comprises a magnetically susceptible material at least partially embedded in at least one of the side, edge, top, bottom, or any combination thereof surface of said utensil. The magnetically susceptible material may be localized in one region of said at least one surface, or spread throughout any area of said at least one surface. Generally exposure of said magnetically susceptible material to a magnetic field of a magnet results in the utensil being magnetically engaged with the magnet. The preferred location of the magnetically susceptible material on or within the utensil of the invention is largely dependent on the processing equipment with which the utensil is to be used. The magnetically susceptible material will be placed on or within the utensil of the invention in order to best suit the processing apparatus.

### EXAMPLES

The following examples are provided to illustrate the present invention. The examples are not intended to and do not limit the scope of the claims of the present invention, and should not be so interpreted.

In the following examples, a small amount of material was removed from a simple two part injection moulding die which was modified to provide extra depth in the female half of the die, centered in the die section in the form of a circle. While the injection moulding die was open, a steel insert shaped as an annulus, was positioned over the central injection nose. The metal insert was held in place by using a small magnet and 3 pins. The pins set the depth of the steel insert so that it is equidistantly set between top and bottom surfaces of the finished polymeric baking tin. The injection moulding die is mounted onto a 200 tonne injection moulding machine and the male and female sections of the die are closed, and heated to the desired moulding temperature by means of a hot fluid flowing through the die. It requires about one hour for the temperature on the die to rise from room temperature to the desired moulding temperature before the first injection can occur. The extruder which feeds the thermoplastic polymer into the mould is heated to a temperature that allows it to melt and inject polymer into the mould.

### Example 1

QUESTRA WA210B (glass reinforced syndiotactic polystyrene) which has been dried for 1 hour at 70° C. is fed from a hopper into the extruder. The extruder is heated from 290° C. up to 310° C. at the injection nose. The mould is heated to 90° C. The SPS (120 grams) in injected in less than 1 second at 140 bar (14 MPa) into the mould and held for about 15 seconds until the polymer cools sufficiently to hold its shape. The mould is opened and the part is ejected as a finished baking tin with a magnetically susceptible metal insert that allows the thermoplastic to be firmly held by a magnetic field.

### Example 2

AMODEL AT HSBK324 (glass reinforced high temperature toughened polyphthalamide) which has been dried for 4 hour at 121° C. is fed from a hopper into the extruder. The extruder is heated from 315° C. up to 335° C. at the injection nose. The mould is heated to 135° C. The AMODEL (140 grams) in injected in less than 1 second at 140 bar (14 MPa) into the mould and held for about 15 seconds until the polymer cools sufficiently to hold its shape. The mould is opened and the part is ejected as a finished baking tin with a magnetically susceptible metal insert that allows the thermoplastic to be firmly held by a magnetic field.

### Example 3

Ryton R4 230BL (glass reinforced polyphenylene sulfide) which has been dried for 4 hours at 135° C. is fed from a hopper into the extruder. The extruder is heated from 290° C. up to 330° C. at the injection nose. The mould is heated to 135° C. The Ryton (170 grams) in injected in less than 1 second at 140 bar (14 MPa) into the mould and held for about 15 seconds until the polymer cools sufficiently to hold its shape. The mould is opened and the part is ejected as a finished baking tin with a magnetically susceptible metal insert that allows the thermoplastic to be firmly held by a magnetic field.

### Example 4

Xtel XK2340 (glass reinforced blend of PPS/Nylon) which has been dried for 6 hour at 80° C. is fed from a hopper into the extruder. The extruder is heated from 270° C. up to 290° C. at the injection nose. The mould is heated to 110° C. The Xtel (160 grams) in injected in less than 1 second at 140 bar (14 MPa) into the mould and held for about 15 seconds until the polymer cools sufficiently to hold its shape. The mould is opened and the part is ejected as a finished baking tin with a magnetically susceptible metal insert that allows the thermoplastic to be firmly held by a magnetic field.

### Example 5

Zytel 80G33 HS1L (glass reinforced toughened nylon) which has been dried for 4 hour at 80° C. is fed from a hopper into the extruder. The extruder is heated from 280° C. up to 300° C. at the injection nose. The mould is heated to 80° C. The Zytel (140 grams) in injected in less than 1 second at 140 bar (14 MPa) into the mould and held for about 15 seconds until the polymer cools sufficiently to hold its shape. The mould is opened and the part is ejected as a finished baking tin with a magnetically susceptible metal insert that allows the thermoplastic to be firmly held by a magnetic field.

### Example 5

Ultramid T KR4357 G6 black (glass filled high temperature copolyamide) which has been dried for 12 hours at 100° C. is fed from a hopper into the extruder. The extruder is heated from 300° C. up to 330° C. at the injection nose. The mould is heated to 105° C. The Ultramid is injected in less than 1 second at 140 bar (14 MPa) into the mould and held for about 15 seconds until the polymer cools sufficiently to hold its shape. The mould is opened and the part is ejected as a finished baking tin with a magnetically susceptible metal insert that allows the thermoplastic to be firmly held by a magnetic field.

### Example 6

Vectra E4711 (Liquid crystal polyester polymer) which has been dried for 4 hour at 170° C. is fed from a hopper into the extruder. The extruder is heated from 315° C. up to 345° C. at the injection nose. The mould is heated to 1000C. The Vectra (190 grams) in injected in less than 1 second at 140 bar (14 MPa) into the mould and held for about 15 seconds until the polymer cools sufficiently to hold its shape. The mould is opened and the part is ejected as a finished baking tin with a magnetically susceptible metal insert that allows the thermoplastic to be firmly held by a magnetic field.

### Example 7

Xydar MG-350 (Liquid crystal polyester polymer) which has been dried for 8 hour at 150° C. is fed from a hopper into the extruder. The extruder is heated from 320° C. up to 340° C. at the injection nose. The mould is heated to 800C. The Xydar (190 grams) in injected in less than 1 second at 140 bar (14 MPa) into the mould and held for about 15 seconds until the polymer cools sufficiently to hold its shape. The mould is opened and the part is ejected as a finished baking tin with a magnetically susceptible metal insert that allows the thermoplastic to be firmly held by a magnetic field.

### Example 8

Acudel 22000 BK937 (polyphenisulfone blend) which has been dried for 4 hours at 150° C. is fed from a hopper into the extruder. The extruder is heated from 320° C. up to 350° C. at the injection nose. The mould is heated to 135° C. The Acudel (133 grams) in injected in less than 1 second at 140 bar (14 MPa) into the mould and held for about 15 seconds until the polymer cools sufficiently to hold its shape. The mould is opened and the part is ejected as a finished baking tin with a magnetically susceptible metal insert that allows the thermoplastic to be firmly held by a magnetic field.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

All references cited herein, including research articles, all U.S. and foreign patents and patent applications, are specifically and entirely incorporated by reference.

What is claimed is:

1. A temperature resistant surface comprising a magnetically insusceptible cooking surface, a magnetically insusceptible support member supporting the cooking surface, and a magnetically susceptible component supported by the support member.

2. The surface of claim 1 wherein said surface comprises any one of the group consisting of polymeric material, ceramic, glass, tile, stone, and any combination thereof.

3. The surface of claim 1 wherein said magnetically susceptible component comprises metal.

4. The surface of claim 1 wherein said surface is for baking a food product.

5. A utensil formed from magnetically insusceptible polymeric material wherein said utensil comprises a magnetically susceptible component at least partially embedded therein.

6. The utensil of claim 5 wherein said polymeric material is selected from the group consisting of thermoplastic resins, cross-linked thermoplastic resins, thermosetting plastic resin, inorganic thermoset material, and any combinations thereof.

7. The utensil of claim 5 wherein said utensil is selected from the group consisting of tins, pans, trays, racks, and sheets.

8. The utensil of claim 5 wherein said utensil has any regular or irregular polygonal or curvilinear shape.

9. A baking utensil comprising a main body consisting essentially of magnetically insusceptible material selected from the group consisting of polymeric material, ceramic, glass, tile, stone, and any combinations thereof, and comprising a magnetically susceptible component supported by the main body.

10. The utensil of claim 9 wherein said utensil is selected from the group consisting of pans, trays, racks and sheets.

11. The utensil of claim 9 wherein the utensil is shaped to contain a flowable material.

12. A method of processing a food product comprising the steps of: a) positioning a utensil at a foodstuff depositing station, b) depositing foodstuff onto said utensil, and c) moving said utensil supporting said foodstuff to one or more processing stations, wherein the utensil comprises a main body consisting essentially of magnetically insusceptible material selected from the group consisting of polymeric material, ceramic, glass, tile, stone, and any combinations thereof, and comprises a magnetically susceptible component supported by the main body, and wherein the moving of step c) is accomplished by magnetically engaging the magnetically susceptible component to facilitate the moving.

13. The method of claim 12 wherein said one or more processing stations is selected from the group consisting of a heating station, a cooking station, a baking station, a cooling station, a freezing station, and any combinations thereof.

14. An apparatus for processing food comprising: a) a utensil b) a transportation device for moving food processing utensils, c) a depositing station for depositing foodstuff onto food processing utensils, d) at least one processing station for processing said deposited foodstuff, wherein the utensil comprises a main body consisting essentially of magnetically insusceptible material selected from the group consisting of polymeric material, ceramic, glass, tile, stone, and any combinations thereof, and comprises a magnetically susceptible component supported by the main body, and wherein the transportation device comprises a magnetic for magnetically engaging the magnetically susceptible component.

15. The apparatus of claim 14 wherein the at least one processing station is selected from an oven or a cooling station.

16. The apparatus of claim 14 wherein said transportation device is magnetically engageable with said magnetically susceptible component of the utensil of the invention.

17. A method of moving a utensil from a first place to a second place, wherein the utensil comprises a main body consisting essentially of magnetically insusceptible material selected from the group consisting of polymeric material, ceramic, glass, tile, stone, and any combinations thereof, and comprises a magnetically susceptible component supported by the main body, said method comprising the steps of: a) magnetically engaging said magnetically susceptible material with a transportation device, and b) moving said utensil from a first place to a second place.

18. The method of claim 17 wherein said transportation device comprises a mechanical arm, a conveyer, or both.

19. The method of claim 17 further comprising the step of moving said utensil to a subsequent place.

20. A food product comprising a utensil supporting a foodstuff wherein the utensil comprises a main body consisting essentially of magnetically insusceptible material selected from the group consisting of polymeric material, ceramic, glass, tile, stone, and any combinations thereof, and comprises a magnetically susceptible component supported by the main body.

21. The product of claim 20 wherein said food product has been baked.

22. A method of making a utensil comprising a main body consisting essentially of magnetically insusceptible material, and comprising a magnetically susceptible component supported by the main body, the method comprising the steps of: a) placing magnetically susceptible material in a predetermined position in an injection die, b) injecting polymeric resin into said die, and c) forming a utensil in a predetermined form.

23. The method of claim 23 wherein said utensil comprises a side, edge, top or bottom surface, and wherein said magnetically susceptible material is at least partially embedded in at least one of said side, edge, top or bottom surface.
